(19) United States
(12) Patent Application Publication
(10) Pub. No.: US 2010/0116358 A1
(43) Pub. Date: May 13, 2010

(54) DUST-REMOVAL MANAGING PIT

(75) Inventor: Seiichiro Takai, Tokyo (JP)

Correspondence Address: GREENBLUM & BERNSTEIN, P.L.C., 1950 ROLAND CLARKE PLACE, RESTON, VA, 20191, US

(73) Assignee: TOTETU MFG. CO. LTD., Tokyo (JP)

(21) Appl. No.: 12/597,827

(22) PCT Filed: Feb. 6, 2008
(86) PCT No.: PCT/JP2008/051938

§ 371 Date: Oct. 27, 2009

(30) Foreign Application Priority Data
May 17, 2007 (JP) 2007-131097
Jul. 23, 2007 (JP) 2007-190638

(51) Int. Cl. E03B 3/02; E03B 11/14; C02F 1/00; B01D 21/34; E03F 5/14

(52) U.S. Cl. 137/356; 137/363; 210/170.03; 210/137; 210/163

(57) ABSTRACT

To facilitate cleaning and to facilitate management thereof, a dust-removal managing pit is provided with an upper pit having a bottom and to which an inflow pipe is connected and a cylindrical lower vertical pit having its upper part connected to the upper pit for supplying water flowing down from an upper-end opening portion to a water storage tank. The upper end of the lower vertical pit is provided penetrating a bottom wall of the upper pit, while a peripheral wall of the upper pit is provided so as to surround the upper end of the lower vertical pit, and a peripheral groove for precipitating solid substances contained in water is formed between the periphery of the upper end of the lower vertical pit and the peripheral wall. A mesh plate constituted capable of filtering water leading to the peripheral groove is provided on the upper pit. One end of a drain pipe with the other end connected to a sewer pipe is connected to the peripheral wall, and an adjusting valve is provided in the drain pipe. A bottom face of the peripheral wall is formed with inclination with respect to a horizontal plane by lowering the side to which the drain pipe is connected so that the water in the peripheral groove flows into the drain pipe, and an inner face of the peripheral wall is formed with curvature or inclination so that a width of the inside of the peripheral wall from the inflow pipe side toward the drain pipe side is decreased.

### TECHNICAL FIELD

The present invention relates to a dust-removal managing pit provided in connection with a water storage tank for storing water, sewers and the like buried under the ground and for removing dust from water supplied to the water storage tank, sewers and the like.

### BACKGROUND ART

Such a facility for effectively using rainwater has been known that a water storage tank buried under the ground for storing rainwater in the water storage tank. This facility is configured such that rainwater falling on a roof or a rooftop of a house or on the ground is collected by a gutter or a groove, the collected water is introduced to an inflow pipe, and the water is supplied to the water storage tank through the inflow pipe so as to be stored inside the tank. Also, in such a facility, water discharge means such as a pump capable of extracting water stored inside from above the ground is provided so that the water stored inside can be extracted and used by the water discharge means.

Also, such a facility to avoid occurrence of so-called flood has been known that a water storage tank is buried under the ground and excess rainwater is temporarily stored in the water storage tank so as to prevent the excess rainwater from flowing to the surface of the ground. With this facility, if rainwater flowing in a river on the ground surface is raised to a predetermined level or more, excess rainwater is temporarily stored in the water storage tank through an inflow pipe and the water storage tank buried under the ground is constructed such that the temporarily stored rainwater can permeate the peripheral soil. Therefore, the facility is configured such that the rainwater temporarily stored in the water storage tank leaks out to the soil around the water storage tank during fine weather after that so as to form a space inside for storing rainwater again, and a space which can temporarily store a predetermined amount of rainwater during rain after that is prepared all the time.

As a water storage tank used in these facilities and which can be installed under the ground relatively easily, such a facility has been known that is formed by excavating a place to form an underground water storage tank, by arranging a sheet at the underground lowermost center portion of the excavated area, and by laminating a water retaining material made of sand, sand gravel, split stone, plastic molded body and the like on the center portion. As a sheet in this case, an impermeable sheet through which rainwater cannot penetrate is used for the purpose of reuse of rainwater, and a permeable sheet, which allows penetration of rainwater, is used for the purpose of avoiding occurrence of flood. After that, the periphery of the sheet is raised, the periphery of the water retaining material is surrounded by the sheet, and by placing an end portion of the sheet on the upper face of the water retaining material so as to wrap the water retaining material with the sheet, the water storage tank is formed. In this underground water storage tank, water is stored in a gap between water retaining materials made of sand, sand gravel, split stone, plastic molded body and the like.

In this type of water storage tank buried under the ground, it is known that a dust-removal managing pit is provided since rainwater falling on a roof or a rooftop of a house or on the ground or water flowing in a river is collected (See Patent Document 1, for example). That is, it is difficult to clean the inside of the water storage tank buried under the ground, and a relatively large amount of dust is contained in the rainwater falling on a roof or a rooftop of a house or on the ground or water flowing in a river. Thus, a dust-removal managing pit for removing a dust from water supplied to the water storage tank is provided in connection with the water storage tank so that the dust contained in the water is removed before the water is supplied to the water storage tank in order to avoid such a situation that the inside of the water storage tank is filled with dusts. In this dust-removal managing pit, water supplied from an inflow pipe is temporarily stored therein, the dust contained in the water is precipitated inside, and the water after the dust has been removed is supplied to the water storage tank through a water supply pipe.

Patent Document 1: WO2006/001139A1 (claim 11, FIG. 18)

### DISCLOSURE OF INVENTION

### Problem to be Solved by the Invention

However, with the prior-art dust-removal managing pit, since the water supplied from the inflow pipe needs to be temporarily stored in the managing pit, the managing pit itself becomes long in the vertical direction, a depth to bury the managing pit becomes relatively deep, and a removal work if the dust precipitated inside the managing pit is accumulated takes labor, which are nonconformities and makes management difficult.

Also, it is also examined if this type of dust-removal management pit is provided beside a road and used for a road for guiding rainfall on the road to a sewer, and if the pit is provided beside a road, it is required that inflowing soil or dust is removed from water relatively easily so as to prevent clogging of a permeable layer provided consecutively to the dust-removal managing pit and to prevent the soil or dust from flowing into a sewer.

The present invention has an object to provide a dust-removal managing pit in which soil or dust is separated from inflowing water and the soil or dust is prevented from flowing into a water storage tank, a permeable pit, a sewer and the like.

The present invention has another object to provide a dust-removal managing pit that is easily cleaned and can be easily managed.

### Means for Solving Problem

An invention according to claim 4 is, as shown in FIG. 1, characterized in that the present invention is provided with an upper pit 22 having a bottom and buried so that its upper end is exposed to the surface of the ground and to which an inflow pipe 20a is connected and a cylindrical lower vertical pit 23 having its upper part connected to the upper pit 22 for having water supplied from the inflow pipe 20a flow down from an upper-end opening portion, an upper end of the lower vertical pit 23 is provided so as to penetrate a bottom wall 22a of the upper pit 22, while a peripheral wall 22b of the upper pit 22 is provided so as to surround the upper end of the lower vertical pit 23, a peripheral groove 33 for precipitating solid substances contained in water supplied from the inflow pipe 20a and flowing into the upper-end opening portion of the lower vertical pit 23 is formed between the upper-end periphery of the lower vertical pit 23 penetrating the bottom wall 22a and the peripheral wall 22b, a drain pipe 36 for draining water in the peripheral groove 33 is connected to the peripheral groove 33, and a bottom face of the peripheral groove 33 is formed with inclination with respect to a horizontal plane so that the water in the peripheral groove 33 flows into the drain pipe 36 by lowering the side to which the drain pipe 36 is connected.

With the dust-removal managing pit described in claim 4, since the peripheral groove 33 for precipitating the solid substances contained in water is formed, dusts constituted by the solid substances can be removed from the water flowing down to the lower vertical pit 23 by the peripheral groove 33. Thus, contamination by dusts on the inside of a water storage tank 10, a sewer and the like to which water is supplied through the lower vertical pit 23 can be prevented, for example. Also, if the dust-removal managing pit is provided in a groove or the like beside a road shown in FIG. 6, inflowing soil or dusts can be separated from water, and clogging of a permeable layer provided consecutively to the dust-removal managing pit can be prevented.

Here, the peripheral groove 33 is formed between the upper-end periphery of the lower vertical pit 23 penetrating the bottom wall 22a of the upper pit 22 and the peripheral wall 22b of the upper pit 22 and is located at a relatively shallow position. Thus, if dusts precipitated in the peripheral groove 33 are accumulated, removal of dusts in the peripheral groove 33 is relatively easy.

On the other hand, the lower vertical pit 23 is vertically long and its buried depth can be relatively deep, but since the water having dusts precipitated in the peripheral groove 33 flows down into the lower vertical pipe 23, an amount of dusts accumulated inside the lower vertical pipe 23 is extremely reduced than before, and a cleaning frequency of the inside of the lower vertical pipe 23 is decreased. Therefore, a management burden of the dust-removal managing pit of the present invention including the upper pit 22 and the lower vertical pipe 23 can be reduced from that of the prior-art managing pit.

Though the peripheral groove 33 is a portion for precipitating solid substances contained in water, if the entire peripheral groove 33 is filled with solid substances, it becomes difficult to remove the solid substances to become dusts from water flowing into the lower vertical pit 23. With the dust-removal managing pit described in claim 4, since the drain pipe 36 is connected to the peripheral groove 33, water in the peripheral groove 33 can be drained together with the solid substances precipitated therein to the outside of the peripheral groove 33 through the drain pipe 36, and by connecting the drain pipe 36 to a sewer pipe, the solid substances can be made to flow into the sewer pipe together with the water. As a result, a situation that the peripheral groove 33 is filled with the solid substances can be effectively avoided.

An invention according to claim 5 is, in the invention according to claim 4 and moreover as shown in FIG. 2, characterized in that the inflow pipe 20a and the drain pipe 36 are connected at opposing positions, respectively, in the peripheral wall 22b of the upper pit 22, and an inner face of the peripheral wall 22b is formed with curvature or inclination so that a width inside the peripheral wall 22b from the inflow pipe 20a side toward the drain pipe 36 side is decreased.

With the dust-removal managing pit described in claim 5, the water in the peripheral groove 33 can be quickly guided to the drain pipe 36 together with the solid substance precipitated therein, and a situation that the solid substances remain in the peripheral groove 33 can be effectively avoided.

An invention according to claim 6 is, in the invention according to claim 4 or 5, characterized in that a grit tank 37 communicating with the peripheral groove 33 is provided adjacently to the upper pit 22, and the drain pipe 36 is connected to the peripheral groove 33 through the grit tank 37.

With the dust-removal managing pit described in claim 6, since the drain pipe 36 is connected to the peripheral groove 33 through the grit tank 37, solid substances constituting dusts precipitated in the peripheral grove 33 can be moved from the peripheral groove 33 and precipitated in the grit tank 37. As a result, unnecessary solid substances are prevented from flowing into the drain pipe 36, and a situation that the peripheral groove 33 is filled with the solid substances can be avoided for a relatively long time.

An invention according to claim 7 is, in the invention according to claim 6, characterized in that a regulating valve 38 that can adjust a water amount flowing into the drain pipe 36 from the grit tank 37 is provided in the grit tank 37.

With the dust-removal managing pit described in claim 7, by regulating the water amount flowing into the drain pipe 36 from the peripheral groove 33 by the regulating valve 38 to a water amount or less flowing into the upper pit 22 from the inflow pipe 20a, the amount of water flowing down from the upper-end opening portion of the lower vertical pit 23 through the peripheral groove 33 into the lower vertical pit 23 can be adjusted to be increased/decreased.

An invention according to claim 8 is, in the invention according to any one of claims 4 to 7, characterized in that a mesh plate 34 constituted so as to cover the upper-end opening portion of the lower vertical pit 23 and the peripheral groove 33 and capable of filtering water supplied from the inflow pipe 20a and leading to the peripheral groove 33 is provided on the upper pit 22.

In the dust-removal managing pit described in claim 8, since the mesh plate 34 is provided, relatively large dusts that can be trapped by the mesh plate 34 from the water supplied from the inflow pipe 20a can be removed from the water leading to the peripheral groove 33. Thus, an amount of the relatively large dusts contained in the water flowing into the lower vertical pit 23 after that can be further decreased.

An invention according to claim 9 is an under-ground water storage system provided with a water storage tank 10 buried under the ground and the dust-removal managing pit 20 described in any one of claims 4 to 8, provided in connection with the water storage tank 10 so that water flowing down from the upper-end opening portion of the lower vertical pit 23 is supplied to the water storage tank 10.

### EFFECT OF THE INVENTION

With the dust-removal managing pit of the present invention, since the peripheral groove is formed between the periphery of the upper end of the lower vertical pit penetrating the bottom wall and the peripheral wall for precipitating solid substances contained in water supplied from the inflow pipe and flowing into the upper-end opening portion of the lower vertical pit, dusts constituted by the solid substances contained in the water flowing into the lower vertical pit can be reduced, and dusts can be removed from the water supplied to a water storage tank, a penetration pit, a sewer and the like with a high probability. Here, the peripheral groove is formed between the periphery of the upper end of the lower vertical pit penetrating the bottom wall of the upper pit and the peripheral wall of the upper pit and is located at a relatively shallow position. Therefore, if dusts precipitated in the peripheral groove are accumulated, cleaning thereof is relatively easy. On the other hand, the lower vertical pit is vertically long and its buried depth can be relatively deep, but since the water having dusts precipitated in the peripheral groove flows down into the lower vertical pipe, an amount of dusts accumulated inside the lower vertical pipe becomes smaller than before, and a cleaning frequency of the inside of the lower vertical pipe is decreased. Therefore, a management burden of the dust-removal managing pit of the present invention including the upper pit and the lower vertical pipe can be reduced from that of the prior-art managing pit.

In this case, by providing the mesh plate covering the upper-end opening portion of the lower vertical pit and the peripheral groove and constructed capable of filtering water supplied from the inflow pipe and leading to the peripheral groove on the upper pit, an amount of relatively large-sized 20 dusts contained in the water flowing down to the lower vertical pit after that can be further reduced, and by connecting the drain pipe to the peripheral groove, a situation that the peripheral groove is filled with solid substances can be effectively avoided. Also, by forming the 25 bottom face of the peripheral groove with inclination with respect to the horizontal plane with the side to which the drain pipe is connected is lower so that the water in the peripheral groove flows down into the drain pipe, and by forming the inner face of the peripheral wall with curvature or inclination so that a width inside the peripheral wall of the upper pit from the inflow pipe side toward the drain pipe side is decreased, water in the peripheral groove can be quickly guided to the drain pipe together with the solid substance precipitated therein, and a situation that the solid substances remain in the peripheral groove can be effectively avoided.

Also, by providing the grit tank communicating with the peripheral groove adjacently to the upper pit and by connecting the drainpipe to the peripheral pipe through the grit tank, solid substances constituting dusts precipitated in the peripheral grove can be moved from the peripheral groove and precipitated in the grit tank, and unnecessary solid substances are prevented from flowing into the drain pipe, and a situation that the peripheral groove is filled with the solid substances can be avoided for a relatively long time. Also, by providing the regulating valve that can adjust a water amount flowing into the drain pipe from the peripheral groove, the amount of water flowing down from the upper-end opening portion of the lower vertical pit through the peripheral groove can be adjusted to be increased/decreased by regulating the water amount discharged from the peripheral groove with the regulating valve.

### BRIEF DESCRIPTION OF DRAWINGS

FIG. 1 is a sectional view illustrating a configuration of a dust-removal managing pit of an embodiment of the present invention;

FIG. 2 is an A-A line sectional view of FIG. 1;

FIG. 3 is a sectional view corresponding to FIG. 1 illustrating a configuration of another dust-removal managing pit in which a lower end of a lower vertical pipe is connected to a water storage tank;

FIG. 4 is a sectional view corresponding to FIG. 1 illustrating a configuration of still another dust-removal managing pit in which a grit tank is brought into close contact with ah upper pit;

FIG. 5 is a B-B line sectional view of FIG. 4; and

FIG. 6 is a sectional view illustrating a configuration of a dust-removal managing pit of another embodiment of the present invention.

### EXPLANATIONS OF LETTERS OR NUMERALS

10 water storage tank
20 dust-removal managing pit
20a inflow pipe
22 upper pit
22a bottom wall
22b peripheral wall
23 lower vertical pit
33 peripheral groove
34 mesh plate
36 drain pipe
37 grit tank
38 regulating valve

### BEST MODE(S) FOR CARRYING OUT THE INVENTION

A best mode for carrying out the present invention will be described below based on the attached drawings.

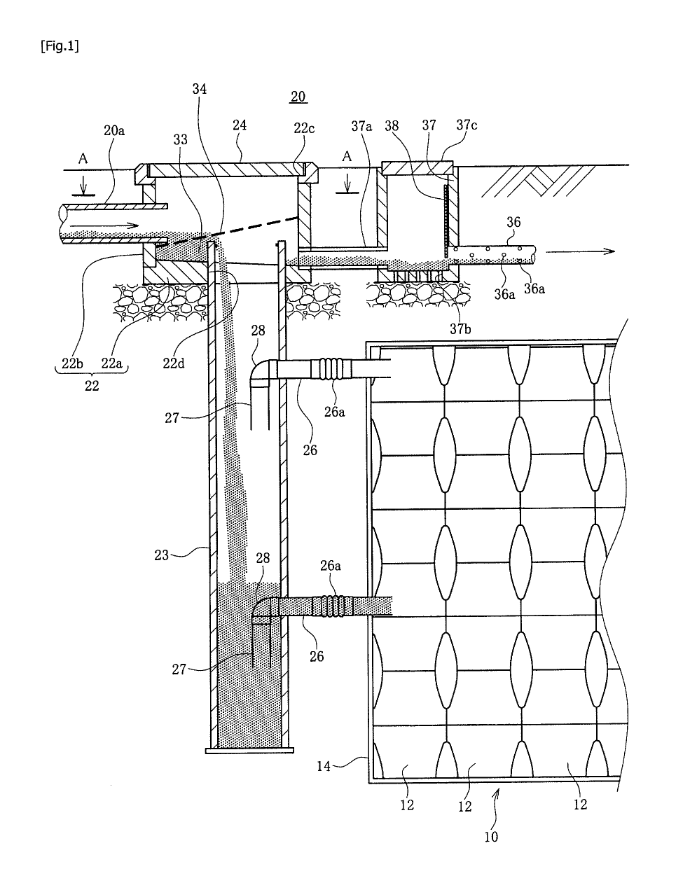

As shown in FIG. 1, a dust-removal managing pit 20 in this embodiment is provided by being connected to a water storage tank 10 in illustration. The water storage tank 10 is buried under the ground, and this water storage tank 10 stores rainwater falling on a roof or a rooftop of a house or on the ground inside so that the water stored inside is extracted by water discharge means, not shown, so as to be reused. The water storage tank 10 exemplified in FIG. 1 is formed by covering an assembly constituted by combining a plurality of water retaining materials 12 with an impervious sheet 14. As the water retaining material 12 in this embodiment, a plastic molded body 12 molded by a die is used. The water retaining material 12 made of the plastic molded body is formed in a truncated pyramid shape, disposed laterally and longitudinally and then, laminated thereon so as to obtain an assembly of the water retaining materials 12. On the other hand, the impervious sheet 14 covering these water retaining materials 12 is an impervious sheet made of synthetic rubber, synthetic resin and the like, and nonwoven cloth for protection is usually overlapped on both sides thereof.

The water storage tank 10 is formed by arranging the impervious sheet 14 in an excavated spot, the water retaining materials 12 are disposed laterally and longitudinally as well as vertically at the center portion so as to obtain an assembly and then, by raising the periphery of the impervious sheet 14 and surrounding the periphery of the assembly of the water retaining materials 12 with the impervious sheet 14, and by further placing an end portion of the impervious sheet 14 on an upper face of the water retaining materials 12 so as to wrap the assembly of the water retaining materials 12 with the impervious sheet 14. Here, if the single impervious sheet 14 does not have a size to wrap the assembly of the water retaining materials 12, a plurality of the impervious sheets 14 are prepared and thermally deposited at end edges thereof so as to integrate them and to obtain a sufficient size to wrap the assembly of the water retaining materials 12 and also to obtain the impervious sheet 14 which prevents water leakage at the deposited portions. The water storage tank 10 constituted as above is capable of storing water in a gap between the water retaining materials 12.

The dust-removal managing pit 20 of the present invention provide by being connected to the water storage tank 10 is provided with an upper pit 22 having a bottom and buried so that its upper end is exposed to the surface of the ground and to which an inflow pipe 20a is connected and a lower vertical pit 23 having its upper part connected to the upper pit 22. The lower vertical pit 23 is connected to the water storage tank 10. Here, the inflow pipe 20a connected to the upper pit 22 leads water falling on a roof or a rooftop of a house or on the ground and collected to the upper pit 22.

The upper pit 22 is provided with a bottom wall 22a and a peripheral wall 22b. The peripheral wall 22b is formed with a size that can surround the upper end of the lower vertical pit 23, and the inflow pipe 20a is connected to the peripheral wall 22b. On an upper edge of the peripheral wall 22b, a stepped portion 22c on which the periphery of a lid plate 24 is seated is formed, and by seating the periphery of the lid plate 24 on the stepped portion 22c, the lid body 24 closing an upper-end opening portion of the upper pit 22 capable of opening is provided on the upper pit 22.

On the bottom wall 22a of the upper pit 22, a hole 22d corresponding to an upper-end outline of the lower vertical pit 23 is formed, and the upper end of the lower vertical pit 23 is inserted through the hole 22d, and the upper end of the lower vertical pit 23 is provided penetrating the bottom wall 22a of the upper pit 22. That is, the upper end of the lower vertical pit 23 is provided penetrating the bottom wall 22a of the upper pit 22 so that a peripheral groove 33 is formed between the periphery of the upper end of the lower vertical pit 23 and the peripheral wall 22b. Then, the peripheral groove 33 formed in the periphery of the upper end of the lower vertical pit 23 and inside the upper pit 22 is configured to temporarily store water supplied from the inflow pipe 20a and flowing into the upper-end opening portion of the lower vertical pit 23 and precipitate solid substances contained in the water.

Also, to the peripheral groove 33, one end of the drain pipe 36 with the other end connected to a sewer pipe, not shown, is connected. This drainpipe 36 is to have water in the peripheral groove 33 flow into the sewer pipe, and for the drainpipe 36 in this embodiment, a so-called porous pipe in which a plurality of small holes 36a are formed on the periphery is used. The drain pipe 36 made up of the porous pipe is buried under the ground, penetrates water inflowing from the peripheral groove 33 to the ground around it and has excess water flow into the sewer pipe, not shown.

Also, in the upper pit 22 in this embodiment, a grit tank 37 communicating with the peripheral groove 33 is provided adjacently. The grit tank 37 in FIG. 1 is a so-called penetration-type pit having a lid 37c in which a plurality of through small holes 37b capable of transmitting water formed in a bottom portion and is buried along with the upper pit 22 with a predetermined interval from the upper pit 22, and the upper pit 22 and the grit tank 37 are connected to a connection pipe 37a. The peripheral groove 33 formed inside the upper pit 22 communicates with the grit tank 37 through the connection pipe 37a, and one end of the drain pipe 36 is connected to the grit tank 37. As a result, the drain pipe 36 is configured to be connected to the peripheral groove 33 through the grit tank 37. The inflow pipe 20a and the drain pipe 36 are connected at opposing positions in the peripheral wall 22b of the upper pit 22, respectively, and the drain pipe 36 is connected at a position lower than the inflow pipe 20a. An upper face of the bottom wall 22a constituting the bottom face of the peripheral groove 33 is formed with inclination with respect to the horizontal plane with the side to which the drain pipe 36 is connected is lower so that water in the peripheral groove 33 flows down into the drain pipe 36 through the connection pipe 37a and the grit tank 37.

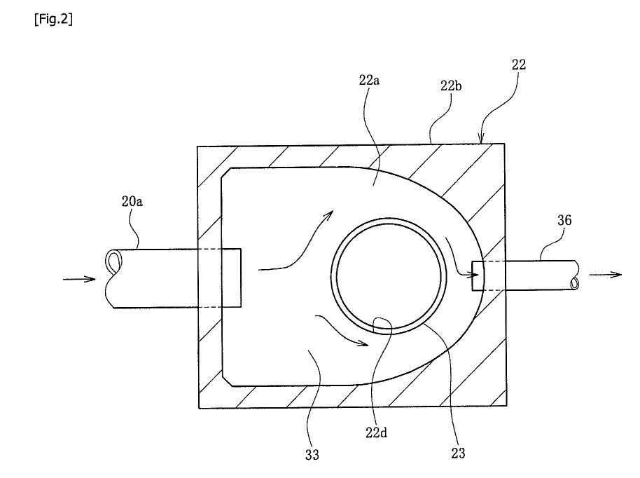

Also, as shown in FIG. 2, the inner face of the peripheral wall 22b is formed with curvature or inclination so that the width of the inside of the peripheral wall 22b extending from the inflow pipe 20a side to the drain pipe 36 side through the connection pipe 37a is decreased. In FIG. 2, an example is shown in which a corner portion at both sides of the peripheral wall 22b to which the drain pipe 36 is connected is formed with curvature in an arc state around the lower vertical pipe 23.

Returning to FIG. 1, on a side wall to which the drain pipe 36 of the grit tank 37 is connected, an adjusting valve 38 constituted capable of adjusting a water amount flowing into a sewer pipe from the peripheral groove 33 by increasing/decreasing a sectional area of the drain pipe 36 is provided. By adjusting the water amount flowing from the peripheral groove 33 into the sewer pipe to a water amount or less flowing from the inflow pipe 20a to the upper pit 22 by the adjusting valve 38, the water amount flowing down from the upper-end opening portion of the lower vertical pit 23 into the lower vertical pit 23 through the peripheral groove 33 is configured capable of being increased/decreased.

On the other hand, the lower vertical pit 23 is cylindrical and is configured such that its upper part is connected to the upper pit 22 and water supplied form the inflow pipe 20a to the upper pit 22 flows down from the upper-end opening portion through the peripheral groove 33. The lower vertical pit 23 supplies water flowing down from the upper-end opening portion to the water storage tank 10, and in this embodiment, after the flowing-down water is stored inside, the stored water is supplied through a vertical pipe 27 and a water supply pipe 26 to the water storage tank 10 present around them.

The vertical pipe 27 and the water supply pipe 26 in this embodiment are constructed by extrusion-molded pipes made of vinyl chloride having a circular section. FIG. 1 shows a case in which the water supply pipes 26 are extended horizontally and provided on the lower vertical pit 23 at two spots with a predetermined interval in a vertical direction, and an upper end of the vertical pipe 27 is connected to an end portion of the water supply pipe 26 opened inside the lower vertical pit 23 through a so-called L-shaped pipe 28. In this way, the lower vertical pit 23 and the water storage tank 10 are connected to each other by the water supply pipe 26 for supplying the water stored inside the lower vertical pit 23 to the water storage tank 10, and a bellows 26a for absorbing relative positional fluctuation of the lower vertical pit 23 and the water storage tank 10 is provided on the water supply pipe 26.

On the other hand, the vertical pipe 27 has its lower end opened facing the bottom portion of the cylindrical lower vertical pit 23 with a bottom and is configured such that the water stored inside the lower vertical pit 23 advances and rises from the lower end of the vertical pipe 27 and reaches the water supply pipe 26 from the upper end, flows horizontally through the inside of the water supply pipe 26 and is supplied to the inside of the water storage tank 10 located in the periphery of the lower vertical pit 23. That is, it is configured such that the water stored inside the lower vertical pit 23 is supplied to the water storage tank 10 through the vertical pipe 27. A check valve, not shown, is provided in this vertical pipe 27, the check valve allowing flow of water from inside the lower vertical pipe 23 to the water storage tank 10 when a water level inside the lower vertical pipe 23 is at a water level inside the water storage tank 10 or more and prohibits the flow of the water in the water storage tank 10 into the lower vertical pipe 23 when the water level inside the lower vertical pipe 23 is less than the water level in the water storage tank 10.

Also, into the upper pit 22, a mesh plate 34 is inserted through the upper-end opening portion opened by removing the lid body 24. This mesh plate 34 is provided inside the upper pit 22 with inclination so that the inflow pipe 20a side is located lower and is configured to cover the upper-end opening portion of the lower vertical pit 23 and the peripheral groove 33 in an inclined state. And this mesh plate 34 is constructed capable of filtering water supplied from the inflow pipe 20a and leading to the peripheral groove 33, and the water in the peripheral groove 33 having passed through the mesh plate 34 leads to the upper-end opening portion of the lower vertical pit 23.

In the dust-removal managing pit 20 configured above, water supplied from the outside through the inflow pipe 20a flows down to the upper pit 22, flows down from the upper-end opening portion of the lower vertical pit 23 is stored inside thereof, and then, supplied to the water storage tank 10 through the vertical pipe 23 and the water supply pipe 26. Here, since the peripheral groove 33 is formed in the periphery of the upper end of the lower vertical pit 23 inside the upper pit 22, the peripheral groove 33 precipitates solid substances contained in water supplied from the inflow pipe 20a and flowing into the upper-end opening portion of the lower vertical pit 23. Thus, an amount of dusts contained in the water flowing down from the upper-end opening portion of the lower vertical pit 23 is decreased, the dusts are removed from the water supplied to the water storage tank 10, and a situation that the inside is filled with dusts can be avoided.

In this embodiment, since the mesh plate 34 covering the upper-end opening portion of the lower vertical pit 23 and the peripheral groove 33 and constructed capable of filtering water supplied from the inflow pipe 20a and leading to the peripheral groove 33 is provided on the upper pit 22, the mesh plate 34 removes relatively large dusts that can be captured from the water supplied from the inflow pipe 20a and leading to the peripheral groove 33. Thus, an amount of relatively large dusts contained in the water flowing into the lower vertical pit 23 after that is decreased, and the amount of dusts can be further decreased from the water supplied to the water storage tank 10.

Also, though the peripheral groove 33 is a portion for precipitating solid substances contained in water, if the entire peripheral groove 33 is filled with solid substances, it becomes difficult to remove the solid substances to become dusts from water flowing into the lower vertical pit 23. However, with this dust-removal managing pit, since the drain pipe 36 which has the water in the peripheral groove 33 flow together with the solid substances precipitated therein into a sewer pipe through the drain pipe 36 is provided, a situation that the peripheral groove 33 is filled with the solid substances can be effectively avoided. Particularly in this embodiment, the grit tank 37 communicating with the peripheral groove 33 is provided adjacently to the upper pit 22, and the drain pipe 36 is connected to the peripheral groove 33 through the grit tank 37, the solid substances constituting the dust precipitated in the peripheral groove 33 can be moved from the peripheral groove 33 and precipitated in the grit tank 37. As a result, the unnecessary solid substances are prevented from flowing into the drain pipe 36 and into the sewer pipe, not shown, through the drain pipe 36, and a situation that the peripheral groove 33 is filled with the solid substances can be avoided for a relatively long time.

Also, in this embodiment, the bottom face of the peripheral groove 33 is formed with inclination with respect to the horizontal plane with the side to which the drain pipe 36 is connected is lower so that water in the peripheral groove 33 flows into the drain pipe 36 by lowering the side to which the drain pipe 36 is connected, and the inner face of the peripheral wall 22b is formed with curvature so that the width inside the peripheral wall 22b from the inflow pipe 20a side to the drain pipe 36 side is decreased, the water in the peripheral groove 33 can be quickly guided together with the solid substances precipitated therein to the drain pipe 36, and a situation that the solid substances remains in the peripheral groove 33 can be effectively avoided. Since the adjusting valve 38 that can adjust the water amount flowing from the peripheral groove 33 into the drain pipe 36 through the grit tank 37 is provided in the grit tank 37, the amount of water flowing into the lower vertical pit 23 and supplied to the water storage tank 10 can be adjusted by the adjusting valve 38.

On the other hand, soils and the like precipitated inside the peripheral groove 33 and the lower vertical pit 23 can be cleaned by removing the lid body 24 from the upper pit 22 so as to open the upper-end opening portion by using means which vacuums the bottom portion of the peripheral groove 33 and the lower vertical pit 23 through the opening portion. Similarly, even with the mesh plate 34 which captured relatively large dusts, they can be cleaned by removing the mesh plate 34 from the upper-end opening portion opened by removing the lid body 24 from the upper pit 22. Moreover, even the solid substances and the like precipitated in the grit tank 37 can be cleaned by removing the lid 37c so as to open its upper end and by using means which vacuums the bottom portion. Thus, by cleaning the mesh plate 34, by removing precipitated soils and the like from the bottom portion of the peripheral groove 33 and the lower vertical pit 23, and by removing precipitated solid substances and the like from the bottom portion of the grit tank 37, the dust-removal managing pit 20 of the present invention can be managed appropriately.

Here, the peripheral groove 33 is formed between the periphery of the upper end of the lower vertical pit 23 penetrating the bottom wall 22a of the upper pit 22 and the peripheral wall 22b of the upper pit 22 and is located at a relatively shallow position. Thus, cleaning is relatively easy if dusts precipitated in the peripheral groove 33 are accumulated. On the other hand, the lower vertical pit 23 is vertically long and its buried depth can be relatively deep, but since the water having dusts precipitated in the peripheral groove 33 flows down into the lower vertical pipe 23, an amount of dusts accumulated inside the lower vertical pipe 23 is reduced than before, and a cleaning frequency of the inside of the lower vertical pipe 23 is decreased. Therefore, a management burden of the dust-removal managing pit of the present invention including the upper pit 22 and the lower vertical pipe 23 can be reduced from that of the prior-art managing pit.

In the above-mentioned embodiment, the lower vertical pit 23 is provided in the vicinity of the side portion of the water storage tank 10 but it may be installed upright inside the water storage tank.

Also, in the above-mentioned embodiment, the water storage tank 10 with the purpose of reuse of rainwater is used in explanation, but a water storage tank may be formed by covering an assembly of the water retaining materials 12 with an impervious sheet allowing transmission of rainwater and used as a water storage tank with the purpose of avoiding occurrence of flood.

Also in the above-mentioned embodiment, the corner portion on both sides of the peripheral wall 22b to which the drain pipe 36 is connected is formed with curvature in an arc state around the lower vertical pipe 23, but the inner face of the peripheral wall 22b may be inclined so that the width of the inside of the peripheral wall 22b is decreased as long as remaining of dusts in the corner portion can be prevented.

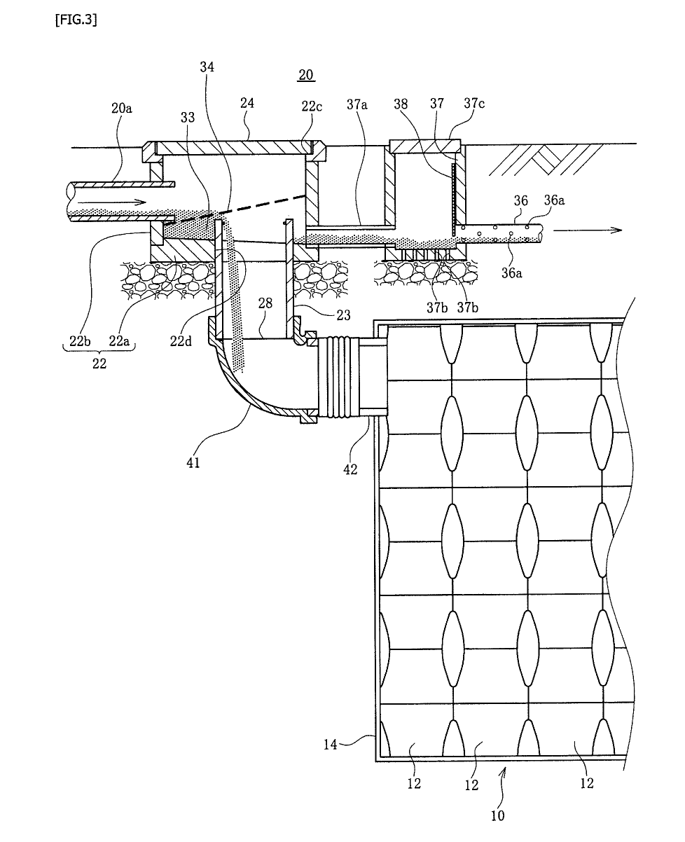

Also, in the above-mentioned embodiment, the case configured such that the water stored in the lower vertical pipe 23 is supplied to the water storage tank 10 through the vertical pipe 27 and the water supply pipe 26 has been described, but it may be so configured that water in the lower vertical pit 23 is supplied to the water storage tank 10 only by the water supply pipe 26, and as shown in FIG. 3, it may be so configured that the lower end of the lower vertical pipe 23 is directly connected to the water storage tank 10 so that the water flowing down from the upper-end opening portion is directly supplied to the water storage tank 10. Here, reference numeral 41 in FIG. 3 denotes a so-called elbow member provided at the lower end of the lower vertical pipe 23 for directly connecting the lower end to the water storage tank 10, and reference numeral 42 denotes a bellows provided between the elbow member 41 and the water storage tank 10 for absorbing fluctuation of the position inbetween.

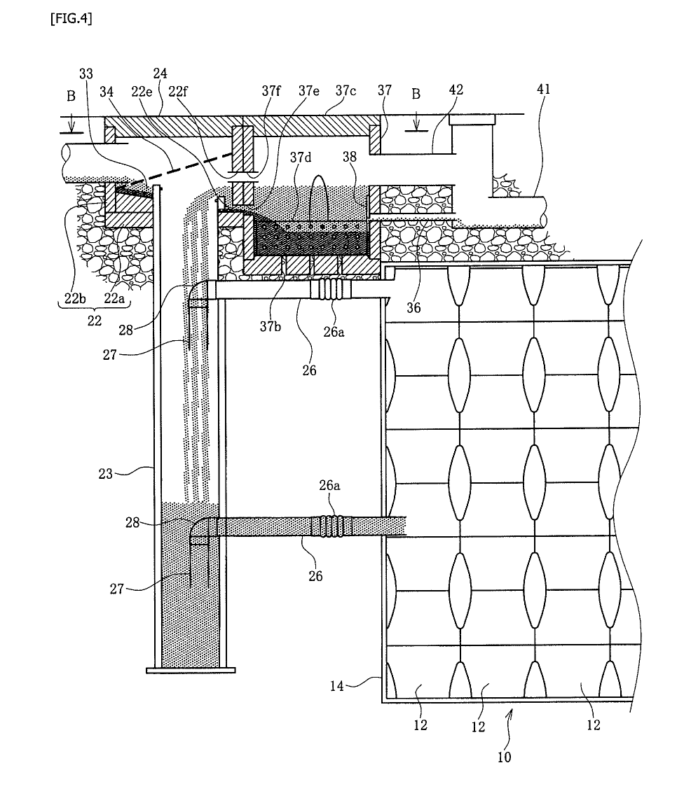

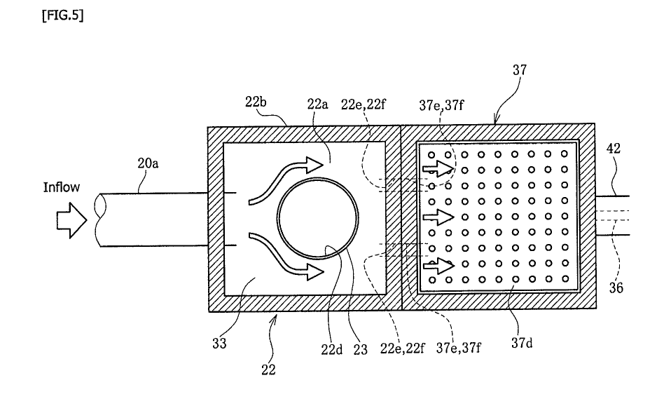

Also, in the above-mentioned embodiment, the case configured such that the grit tank 37 is buried with a predetermined interval from the upper pit 22, and the upper pit 22 and the grit tank 37 are connected to each other by the connection pipe 37a has been described, but as shown in FIGS. 4 and 5, the grit tank 37 may be brought into close contact with the upper pit 22. By bringing the grit tank 37 into close contact with the upper pit 22, they can be integrated before they are buried. Also, by matching communication holes 22e and 37e formed therein with each other, the connection pipe 37a and its connection work, which were required in the above-mentioned embodiment, are no longer needed, and the burying work can be facilitated. Here, reference numeral 41 in FIG. 4 denotes a sewer pipe, and above the drain pipe 36, an overflow pipe 42 is provided in parallel with the drain pipe 36. The drain pipe 36 and the overflow pipe 42 in the figure are usual ones without small holes formed in the periphery, and a case in which the water in the grit tank 37 is made to flow into the sewer pipe 41 without permeating the ground is shown, in which a large diameter pipe as compared with the drain pipe 36 is used as the overflow pipe 42. This overflow pipe 42 prevents exposure of water to the surface of the ground by having the excess water flow into the sewer pipe 41 if a flow rate of the drain pipe 36 is limited by the adjusting valve 38 or a hole diameter of the drain pipe 36 is not sufficient and the flow rate is limited and the water level in the grit tank 37 is raised.

Also, through holes 22f and 37f are formed in the upper pit 22 and the grit tank 37, respectively, above the communication holes 22e and 37e in FIG. 4, and the through holes 22f and 37f prevents water containing solid substances from flowing down through the upper-end opening portion of the lower vertical pit 23 by having excess water flow into the grit tank 37 from the peripheral groove 33 if the flow rate of the water flowing from the peripheral groove 33 into the grit tank 37 through the communication holes 22e and 37e is limited.

Also, in the grit tank 37 in FIG. 4, a basket 37d for collecting solid substances and the like inflowing from the peripheral groove 33 is provided inside. With this basket 37d, by removing the lid 37c of the grit tank 37 so as to open the upper end and by taking out the basket 37d, solid substances precipitated in the grit tank 37 can be taken out of the grit tank 37, and its cleaning work can be further facilitated.

Moreover, in the above-mentioned embodiments, though the inner facer of the peripheral wall 22b is formed with curvature or inclination and the width of the inside of the peripheral wall 22b from the inflow pipe 20a side to the drain pipe 36 side is decreased, it may be so configured that, as shown in FIG. 5, the width of the inside of the peripheral wall 22b is made constant without decreasing the width, and the upper pit 22 and the grit tank 37 are connected to each other at plural spots. Here, in FIG. 5, the case in which the grit tank 37 is brought into close contact with the upper pit 22 is shown, in which the holes 22e and 37e are formed two each in them, and they are matched with each other so as to connect the upper pit 22 and the grit tank 37 at the two spots.

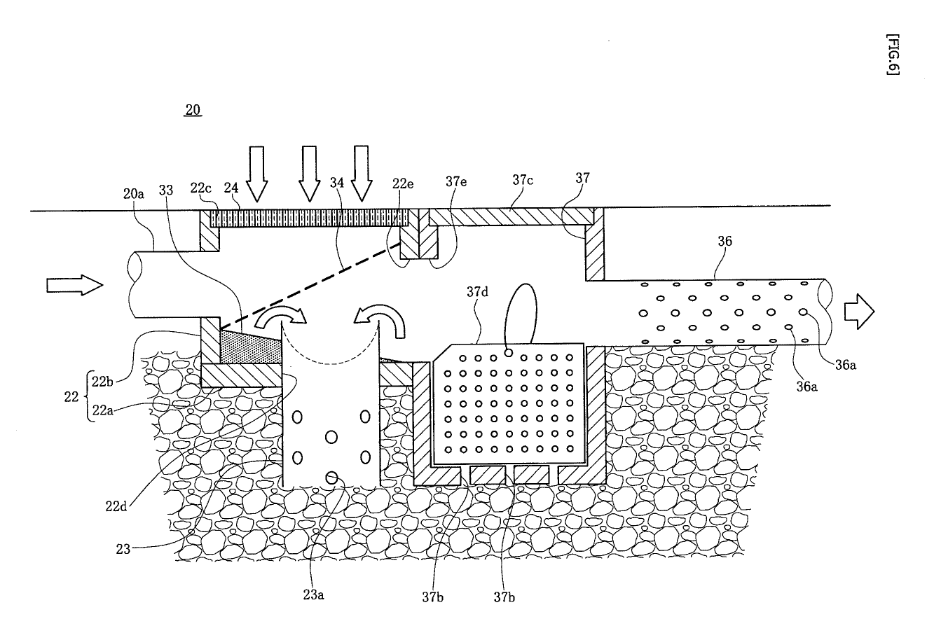

In FIG. 6, another embodiment of the present invention is shown. The same reference numerals as those in the above embodiment denote the same portions in the figure, and repeated description will be omitted.

As shown in FIG. 6, the dust-removal managing pit 20 in this embodiment is for road and is provided in a side ditch for guiding rainfall on the road to a sewer, and the inflow pipe 20a connected to the upper pit 22 is configured to guide the water falling on the road and collected to the upper pit 22. Also, the lid body 24 closing the upper-end opening portion of the upper lid 22 capable of opening is a meshed article and is configured so as to introduce rainwater falling on the road and flowing along the surface into the upper pit 22. The mesh plate 34 is inserted into the upper pit 22 and is configured to cover the upper-end opening portion of the lower vertical pipe 23 and the peripheral groove 33 in an inclined state.

The upper end of the lower vertical pit 23 is inserted through the hole 22d of the upper pit 22, and the upper end of the lower vertical pit 23 is provided penetrating the bottom wall 22a of the upper pit 22 so that the peripheral groove 33 is formed between the periphery of the upper end of the lower vertical pit 23 and the peripheral wall 22b of the upper pit 22. The lower vertical pit 23 is cylindrical and is configured such that water supplied from the inflow pipe 20a flows down from the upper-end opening portion through the peripheral groove 33. And this lower vertical pit 23 is a porous pipe with a relatively large diameter having a plurality of small holes 23a formed in the periphery and a lower end thereof opened, and the lower vertical pit 23 is configured such that by being buried under the ground, water flowing from the upper-end opening portion through the peripheral groove 33 permeates the peripheral ground through the small holes 23a and the lower-end open end.

On the other hand, the grit tank 37 constituting the dust-removal managing pit 20 is provided in close contact with the upper pit 22, and they are provided in close contact with each other in a state in which the relatively large holes 22e and 37e formed therein are matched with each other. In the grit tank 37, the basket 37d for collecting solid substances and the like inflowing from the peripheral groove 33 is provided inside and is configured such that the solid substances and the like precipitated in the grit tank 37 can be taken out by removing the lid 37c so as to open its upper end and by taking out the basket 37d from the upper-end opening portion.

Then, to the grit tank 37, one end of the drain pipe 36 with the other end connected to a sewer pipe, not shown, is connected, and the drain pipe 36 is configured to be connected to the peripheral groove 33 through the grit tank 37. As the drain pipe 36 in this embodiment, a porous pipe in which a plurality of small holes 36a are formed on the periphery is used. By being buried under the ground, the drain pipe 36 made by a porous pipe is configured to permeate water inflowing from the peripheral groove 33 through the grit tank 37 into the peripheral ground, while excess water is made to flow into the sewer pipe, not shown.

The dust-removal managing pit 20 constituted as above is provided in a side ditch beside a road, and rainfall on the road flows into the upper pit 22 through the inflow pipe 20a and lead to the peripheral groove 33. Also, from the upper-end opening portion of the upper pit 22, rainwater falling on the ground and flowing along its surface flows down while relatively large dusts are removed by a mesh-state article, which is the lid body 24 of the upper pit 22, and leads to the peripheral groove 33. In the peripheral groove 33, solid substance contained in water supplied from the inflow pipe 20a and the upper-end opening portion of the upper pit 22 are precipitated, and the water from which the solid substances are removed is made to flow down from the upper-end opening portion of the lower vertical pit 23 and to permeate the peripheral ground from the small holes 23a and the lower-end open end around it. As a result, the water from which the solid substances are removed can be made to flow down from the upper-end opening portion of the lower vertical pit 23, and a situation that the inside of the lower vertical pit 23 is filled with dusts can be avoided.

In the grit tank 37 provided adjacently to the upper pit 22, the solid substances constituting the dusts precipitated in the peripheral groove 33 are moved from the peripheral groove 33 and precipitated in the grit tank 37 so as to prevent inflow of the unnecessary solid substances into the drain pipe 36 and a sewer pipe, not shown, through the drain pipe 36 and to avoid a situation that the peripheral groove 33 is filled with the solid substances for a relatively long time. As a result, a situation that soils and dusts are removed from the inflowing water and the soils and dusts flow into the sewer can be avoided.

On the other hand, soils and the like precipitated inside the peripheral groove 33 and the lower vertical pit 23 can be cleaned by removing the lid body 24 and using means for vacuuming the bottom portions thereof through the upper-end opening portion. Similarly, the lid body 24 and the mesh plate 34 which captured relatively large dusts can be cleaned in a removed state. Moreover, the solid substances precipitated in the grit tank 37 can even be cleaned by removing the lid 37c so as to open the upper end and using means for vacuuming the bottom portion. Here, the peripheral groove 33 is located at a relatively shallow position, and the lower vertical pit 23 is relatively short, and cleaning thereof becomes relatively easy. Therefore, a management burden of the dust-removal managing pit of the present invention including the upper pit 22 and the lower vertical pipe 23 can be reduced from that of the prior-art managing pit.

### INDUSTRIAL APPLICABILITY

The dust-removal managing pit of the present invention can be used by being connected to a water storage tank buried under the ground for storing water, a sewer and the like and can remove dusts from water supplied to the water storage tank, the sewer and the like.

1-3. (canceled)

4. A dust-removal managing pit comprising:
an upper pit having a bottom and buried so that an upper end thereof is exposed to the surface of the ground and to which an inflow pipe is connected; and
a cylindrical lower vertical pit having an upper part thereof connected to said upper pit for having water supplied from said inflow pipe flow down from an upper-end opening portion, wherein
an upper end of said lower vertical pit is provided so as to penetrate a bottom wall of said upper pit, while a peripheral wall of said upper pit is provided so as to surround the upper end of said lower vertical pit;
a peripheral groove for precipitating solid substances contained in water supplied from said inflow _pipe and flowing into the upper-end opening portion of said lower vertical pit is formed between the upper-end periphery of said lower vertical pit penetrating said bottom wall and said peripheral wall;
a drain pipe for draining water in said peripheral groove is connected to said peripheral groove; and
a bottom face of said peripheral groove is formed with inclination with respect to a horizontal plane so that the water in said peripheral groove flows into said drain pipe by lowing the side to which said drain pipe is connected.

5. The dust-removal managing pit according to claim 4, wherein
the inflow pipe and the drain pipe are connected at opposing positions, respectively, in the peripheral wall of the upper pit; and
an inner face of said peripheral wall is formed with curvature or inclination so that a width inside said peripheral wall from said inflow pipe side toward said drain pipe side is decreased.

6. The dust-removal managing pit according to claim 4, wherein
a grit tank communicating with the peripheral groove is provided adjacently to the upper pit, and the drain pipe is connected to the peripheral groove through said grit tank.

7. The dust-removal managing pit according to claim 6, wherein
a regulating valve that can adjust a water amount flowing into the drain pipe from the grit tank is provided in said grit tank.

8. The dust-removal managing pit according to claim 4, wherein
a mesh plate constituted so as to cover an upper-end opening portion of the lower vertical pit and the peripheral groove and capable of filtering water supplied from the inflow pipe and leading to the peripheral groove is provided on the upper pit.

9. An under-ground water storage system, comprising:
a water storage tank buried under the ground; and
the dust-removal managing pit according to claim 4, provided in connection with the water storage tank so that water flowing down from the upper-end opening portion of the lower vertical pit is supplied to said water storage tank.
